(19) United States
(12) Patent Application Publication
(10) Pub. No.: US 2011/0155482 A1
(43) Pub. Date: Jun. 30, 2011

(54) Frictionally Drivable Endless Track for Traction of a Snowmobile or All-Terrain Vehicle (ATV)

(75) Inventors: Denis Courtemanche, Val-Joll (CA); Jules Dandurand, Sherbrooke (CA)

(73) Assignee: CAMOPLAST INC., Sherbrooke (CA)

(21) Appl. No.: 12/826,333

(22) Filed: Jun. 29, 2010

Related U.S. Application Data
(60) Provisional application No. 61/221,251, filed on Jun. 29, 2009.

(51) Int. Cl. B62D 55/24; B62D 55/06; B62D 55/08; B62D 55/12

(52) U.S. Cl. 180/9.1; 305/165

(57) ABSTRACT

An endless snowmobile track for traction of a snowmobile. The endless snowmobile track comprises a ground-engaging outer side for engaging the ground on which the snowmobile travels and an inner side for engaging at least one drive wheel of the snowmobile. The inner side comprises a friction drive surface for frictional engagement with the at least one drive wheel such that, when each of the at least one drive wheel rotates, friction between the friction drive surface and the at least one drive wheel moves the endless snowmobile track to propel the snowmobile on the ground. An endless all-terrain vehicle (ATV) track for traction of an ATV is also provided.

### CROSS-REFERENCE TO RELATED APPLICATION

This application claims the benefit under 35 U.S.C. 119(e) of U.S. Provisional Patent Application No. 61/221,251 filed on Jun. 29, 2009 and hereby incorporated by reference herein.

### FIELD OF THE INVENTION

The invention relates to endless tracks for traction of snowmobiles or all-terrain vehicles (ATVs).

### BACKGROUND

Snowmobiles provide an efficient way of travelling on snowy and in some cases icy grounds. A snowmobile typically comprises an endless track which engages the ground and allows power supplied by a prime mover (e.g., an internal combustion engine) to be converted to forward motion of the snowmobile.

The power supplied by a snowmobile's prime mover is typically transmitted to its endless track through a drive system which comprises a drive sprocket that engages voids of the endless track and/or drive lugs on an inner side of the endless track. As the drive sprocket rotates, teeth or recesses of the drive sprocket engage the voids or drive lugs of the endless track in order to transmit rotational power from the drive sprocket to the endless track, resulting in motion being imparted to the snowmobile.

This drive system has certain disadvantages. For example, the interaction between the drive sprocket and the endless track places certain restrictions on the track's design. In particular, restrictions may be imposed on a tread pattern comprising traction projections (also sometimes referred to as “traction lugs” or “traction profiles”) on a ground-engaging outer side of the endless track. Indeed, when the inner side of the endless track comprises drive lugs, the tread pattern on the track's outer side is typically designed such that each traction projection is generally aligned with one or more drive lugs for proper structural rigidity of the track. Such design limitations on the tread pattern may limit the traction efficiency that can be achieved and thus limit the performance of the snowmobile.

Also, restrictions placed on the endless track due to the drive sprocket may result in a larger and heavier track requiring that the snowmobile be equipped with a larger prime mover than would otherwise be the case. In addition to increasing the cost associated with the snowmobile (e.g., both in terms of equipment cost and exploitation cost, due to higher fuel consumption), this results in noise and air pollution emitted by the snowmobile during use. Since snowmobiles are usually used in environments that are sensitive to such pollutants, a reduction of these detrimental effects, without diminishing the snowmobile's ability to accelerate quickly and travel at high speed, would be welcomed.

Similar issues can arise with all-terrain vehicles (ATVs) equipped with endless tracks that are driven by drive sprockets.

Accordingly, there is a need to improve endless tracks and drive systems of snowmobiles and ATVs.

### SUMMARY OF THE INVENTION

According to a first broad aspect, the invention provides an endless snowmobile track for traction of a snowmobile. The endless snowmobile track comprises a ground-engaging outer side for engaging the ground on which the snowmobile travels and an inner side for engaging at least one drive wheel of the snowmobile. The inner side comprises a friction drive surface for frictional engagement with the at least one drive wheel such that, when each of the at least one drive wheel rotates, friction between the friction drive surface and the at least one drive wheel moves the endless snowmobile track to propel the snowmobile on the ground.

According to a second broad aspect, the invention provides a track assembly for traction of a snowmobile. The track assembly comprises a plurality of wheels and an endless snowmobile track disposed around the wheels. The endless snowmobile track comprises a ground-engaging outer side for engaging the ground on which the snowmobile travels and an inner side for engaging the wheels. The inner side comprises a friction drive surface. The plurality of wheels comprises: at least one drive wheel for driving the endless snowmobile track, each of the at least one drive wheel having a periphery for frictional engagement with the friction drive surface such that, when each of the at least one drive wheel rotates, friction between the friction drive surface and the periphery of each of the at least one drive wheel moves the endless snowmobile track to propel the snowmobile on the ground; and at least one idler wheel spaced apart from the at least one drive wheel along a longitudinal direction of the track assembly.

According to a third broad aspect, the invention provides an endless all-terrain vehicle (ATV) track for traction of an ATV. The endless ATV track comprises a ground-engaging outer side for engaging the ground on which the ATV travels and an inner side for engaging at least one drive wheel of the ATV. The inner side comprises a friction drive surface for frictional engagement with the at least one drive wheel such that, when each of the at least one drive wheel rotates, friction between the friction drive surface and the at least one drive wheel moves the endless ATV track to propel the ATV on the ground.

According to a fourth broad aspect, the invention provides a track assembly for traction of an all-terrain vehicle (ATV). The track assembly comprises a plurality of wheels and an endless ATV track disposed around the wheels. The endless ATV track comprises a ground-engaging outer side for engaging the ground on which the ATV travels and an inner side for engaging the wheels. The inner side comprises a friction drive surface. The plurality of wheels comprises: at least one drive wheel for driving the endless ATV track, each of the at least one drive wheel having a periphery for frictional engagement with the friction drive surface such that, when each of the at least one drive wheel rotates, friction between the friction drive surface and the periphery of each of the at least one drive wheel moves the endless ATV track to propel the ATV on the ground; and at least one idler wheel spaced apart from the at least one drive wheel along a longitudinal direction of the track assembly.

These and other aspects of the invention will now become apparent to those of ordinary skill in the art upon review of the following description of embodiments of the invention in conjunction with the accompanying drawings.

### BRIEF DESCRIPTION OF THE DRAWINGS

A detailed description of embodiments of the invention is provided below, by way of example only, with reference to the accompanying drawings, in which:

FIG. 1 shows an example of a snowmobile in accordance with an embodiment of the invention;

FIG. 2 shows a perspective view of components of a track assembly of the snowmobile of FIG. 1;

FIG. 3 shows another perspective view of components of the track assembly of FIG. 2;

FIG. 4 shows a side view of components of the track assembly of FIG. 2;

FIG. 5 shows a perspective view of part of an endless snowmobile track of the track assembly of FIG. 2;

FIG. 6 shows a front view of part of a drive wheel of the track assembly of FIG. 2;

FIG. 7 shows a perspective view illustrating frictional engagement between the drive wheel and an inner side of the track;

FIG. 8 shows a cross-sectional view of the track;

FIG. 9 shows a cross-sectional view of a track in accordance with another embodiment of the invention;

FIG. 10 shows components of a track assembly in accordance with another embodiment of the invention;

FIG. 11 shows results of tests conducted on endless snowmobile tracks including one in accordance with an embodiment of the invention; and

FIG. 12 shows an example of an all-terrain vehicle (ATV) in accordance with another embodiment of the invention.

It is to be expressly understood that the description and drawings are only for the purpose of illustrating certain embodiments of the invention and are an aid for understanding. They are not intended to be a definition of the limits of the invention.

### DETAILED DESCRIPTION OF EMBODIMENTS

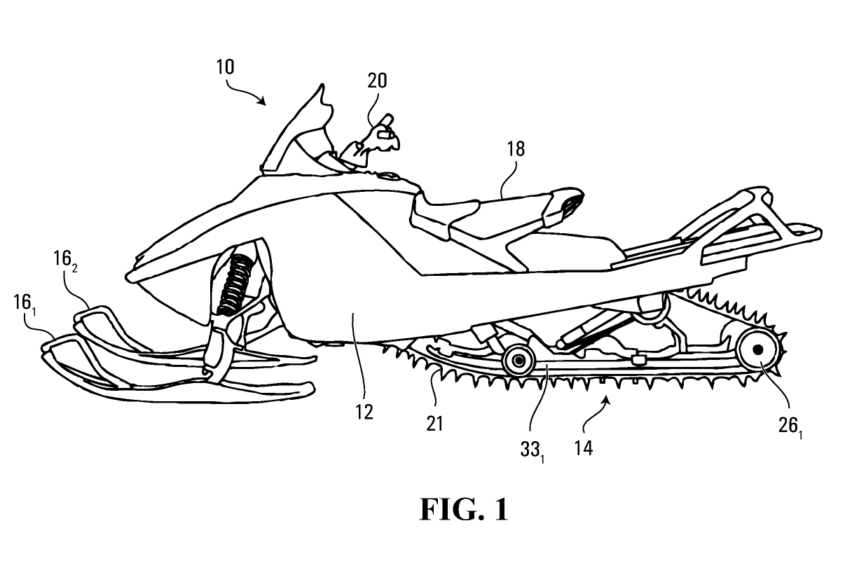

FIG. 1 shows an example of a snowmobile 10 in accordance with an embodiment of the invention. The snowmobile 10 is designed for travelling on snow and/or ice. In this embodiment, the snowmobile 10 comprises a prime mover 12, a track assembly 14, a pair of steering skis 16₁, 16₂, a seat 18, and a user interface 20.

The prime mover 12 provides motive power to move the snowmobile 10 on the ground, which may be snowy and/or icy. In this embodiment, the prime mover 12 comprises an internal combustion engine. In other embodiments, the prime mover 12 may comprise another type of motor (e.g., an electric motor) or a combination of different types of motor (e.g., an internal combustion engine and an electric motor) for generating motive power to move the snowmobile 10. The prime mover 12 is in a driving relationship with the track assembly 14. That is, motive power generated by the prime mover 12 is transmitted to the track assembly 14 via a powertrain of the snowmobile 10 (e.g., via a transmission).

The seat 18 accommodates a rider of the snowmobile 10. In this case, the seat 18 is a straddle seat and the snowmobile 10 is usable by a single person such that the seat 18 accommodates only that person driving the snowmobile 10. In other cases, the seat 18 may be another type of seat, and/or the snowmobile 10 may be usable by two individuals, namely one person driving the snowmobile 10 and a passenger, such that the seat 18 may accommodate both of these individuals (e.g., behind one another or side-by-side) or the snowmobile 10 may comprise an additional seat for the passenger.

The user interface 20 allows the rider to interact with the snowmobile 10. More particularly, the user interface 20 comprises an accelerator, a brake control, and a steering device that are operated by the rider to control motion of the snowmobile 10 on the ground. In this case, the steering device comprises handlebars, although it may comprise a steering wheel or other type of steering element in other cases. The user interface 20 also comprises an instrument panel (e.g., a dashboard) which provides indicators (e.g., a speedometer indicator, a tachometer indicator, etc.) to convey information to the rider.

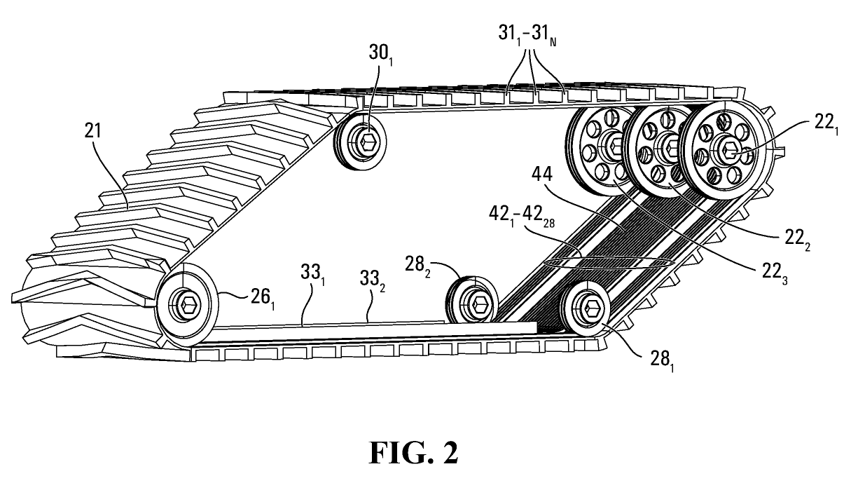

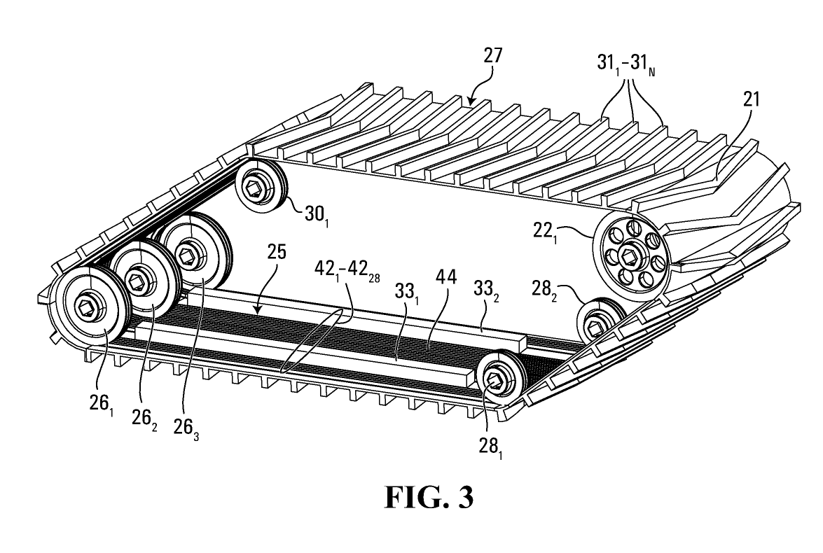

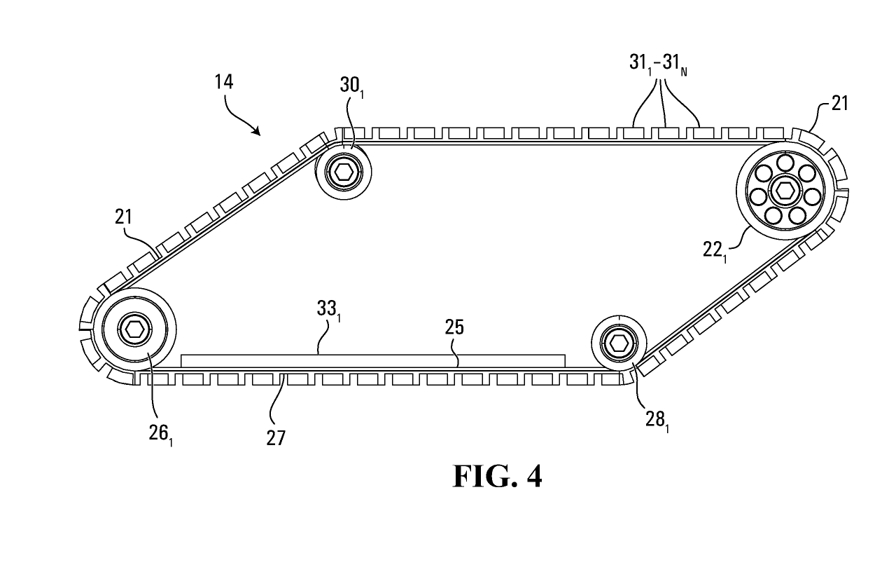

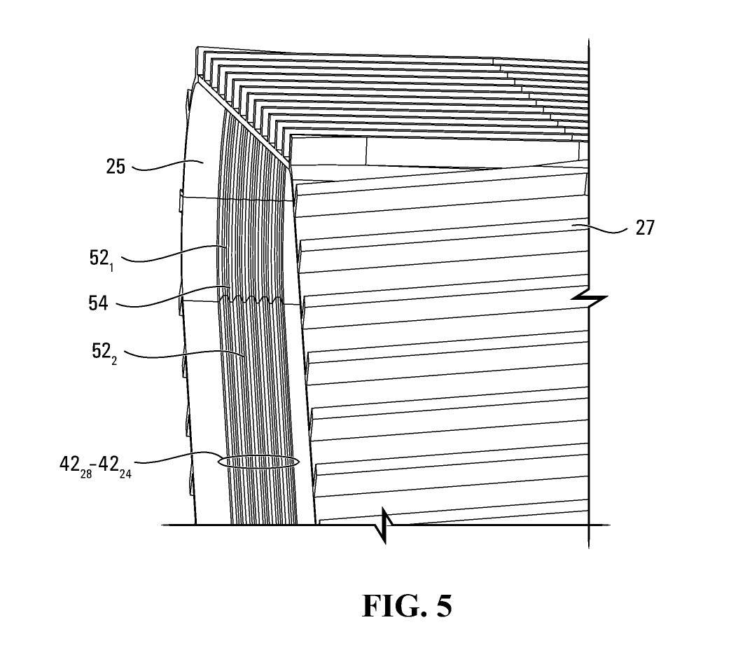

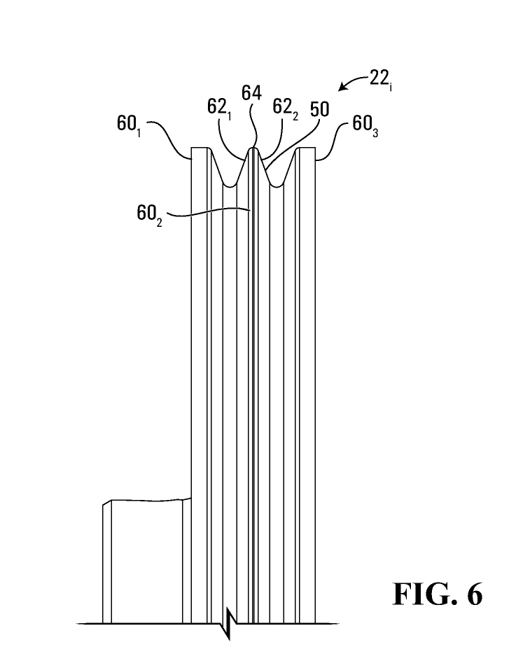

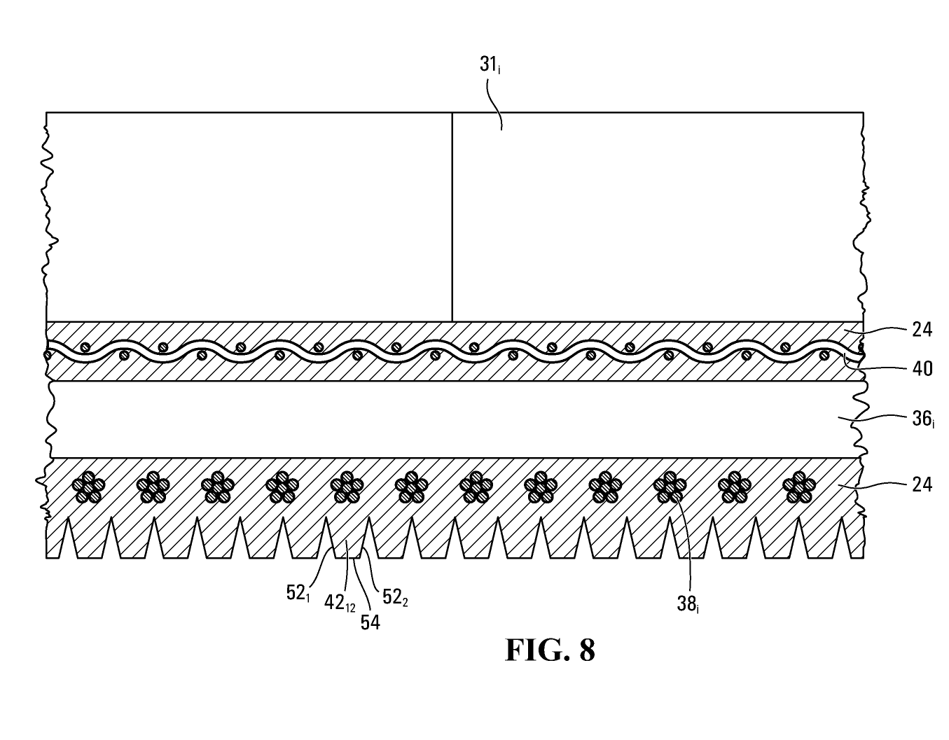

The track assembly 14 generates traction of the snowmobile 10 on the ground. With additional reference to FIGS. 2 to 8, in this embodiment, the track assembly 14 comprises: a plurality of wheels, including a plurality of drive wheels 22₁-22₃, a plurality of rear idler wheels 26₁-26₃, a plurality of lower support wheels 28₁, 28₂, a plurality of upper support wheels 30₁, 30₂; a pair of sliders 33₁, 33₂; and an endless snowmobile track 21 disposed around these wheels and sliders.

The endless snowmobile track 21 provides traction to propel the snowmobile 10 the ground. In this embodiment, the endless snowmobile track 21 comprises an elastomeric body 24 and reinforcements at least partially embedded in the elastomeric body 24, including a plurality of transversal rods 36₁-36_{N}, a layer of longitudinal cables 38₁-38_{M}, and a layer of reinforcing fabric 40.

The elastomeric body 24 is elastomeric in that it comprises elastomeric material that allows the endless snowmobile track 21 to elastically change in shape as it is driven by the drive wheels 22₁-22₃ around the wheels 22₁-22₃, 26₁-26₃, 28₁, 28₂, 30₁, 30₂ and the sliders 33₁, 33₂. The elastomeric material can be any polymeric material with the property of elasticity. In this embodiment, the elastomeric material includes rubber. Various rubber compounds may be used and, in some cases, different rubber compounds may be present in different areas of the body 24. In other embodiments, the elastomeric body 24 may include another elastomer in addition to or instead of rubber (e.g., polyurethane elastomer).

The transversal rods 36₁-36_{N} extend transversally to a longitudinal direction of the endless snowmobile track 21 to enhance transverse rigidity of the track 21. Each of the transversal rods 36₁-36_{N} may have various shapes and be made of any suitably rigid material (e.g., metal, plastic or composite material).

The longitudinal cables 38₁-38ₘ extend generally parallel to the longitudinal direction of the endless snowmobile track 21 to enhance strength in tension of the track 21 along its longitudinal direction. Each of the longitudinal cables 38₁-38_{M} may be a cord including a plurality of strands or another type of cable and may be made of any material suitably flexible longitudinally (e.g., fibers or wires of metal, plastic or composite material).

The layer of reinforcing fabric 40 comprises pliable material made usually by weaving, felting, or knitting natural or synthetic fibers. In this embodiment, the layer of reinforcing fabric 40 comprises a ply of woven fibers (e.g., nylon fibers or other synthetic fibers) to provide reinforcement. For example, the reinforcing fabric 40 may protect the transversal rods 36₁-36_{N}, improve cohesion of the track 21 and counter its elongation.

The endless snowmobile track 21 comprises a ground-engaging outer side 27 and an inner side 25 opposite the ground-engaging outer side 27.

The ground-engaging outer side 27 engages the ground on which the snowmobile 10 travels. In this embodiment, the ground-engaging outer side 27 comprises a plurality of traction projections 31₁-31_{N} which enhance traction of the endless snowmobile track 21 on the ground. In this example, at least part, and in this case all, of a traction projection 31ᵢ extends obliquely to the longitudinal direction of the track 21. More particularly, in this example, each of the traction projections 31₁-31_{N} comprises two (2) portions extending obliquely to the longitudinal direction of the endless snowmobile track 21 and converging towards one another in a direction of forward motion of the track 21 when driven by the drive wheels 22₁-22₃. Each of the traction projections 31₁-31_{N} can thus be viewed as being generally chevron-shaped in this case. The traction projections 31₁-31_{N} may have various other shapes and may be arranged in various other patterns in other examples.

The inner side 25 of the endless snowmobile track 21 engages the wheels 22₁-22₃, 26₁-26₃, 28₁, 28₂, 30₁, 30₂ and the sliders 33₁, 33₂ and defines an inner area of the track 21 in which these wheels rotate. As further discussed below, the inner side 25 is in a friction drive relationship with the drive wheels 22₁-22₃ such that the endless snowmobile track 21 is frictionally driven by the drive wheels 22₁-22₃ to propel the snowmobile 10 on the ground.

More specifically, the inner side 25 comprises a friction drive surface 44 in frictional engagement with the drive wheels 22₁-22₃ such that, when the drive wheels 22₁-22₃ rotate, friction between the friction drive surface 44 and the drive wheels 22₁-22₃ imparts motion to the endless snowmobile track 21, i.e., causes the track 21 to turn around the wheels 22₁-22₃, 26₁-26₃, 28₁, 28₂, 30₁, 30₂ and the sliders 33₁, 33₂, in order to propel the snowmobile 10 on the ground.

The friction drive surface 44 may be configured in various manners. In this embodiment, the friction drive surface 44 comprises a plurality of formations 42₁-42₂₈, some of which are in frictional engagement with the drive wheels 22₁-22₃. Specifically, in this case, the formations 42₁, 42₂ frictionally engage the drive wheel 22₁, the formations 42₁₄, 42₁₅ frictionally engage the drive wheel 22₂, and the formations 42₂₇, 42₂₈ frictionally engage the drive wheel 22₃ such that, when the drive wheels 22₁-22₃ rotate, friction between the formations 42₁, 42₂, 42₁₄, 42₁₅, 42₂₇, 42₂₈ and the drive wheels 22₁-22₃ imparts motion to the endless snowmobile track 21.

More specifically, in this embodiment, each of the formations 42₁-42₂₈ is a projection generally parallel to the longitudinal direction of the endless snowmobile track 21. The projections 42₁-42₂₈ may thus be viewed as longitudinal ridges in this case. Adjacent ones of the projections 42₁-42₂₈ define a recess generally parallel the longitudinal direction of the track 21.

Each projection 42ᵢ includes an end surface 54 and a pair of side surfaces 52₁, 52₂ that lie opposite one another. The projection 42ᵢ has a height, which is measured from its end surface 54 to a level of the inner side 25 from which it projects. The height of the projection 42ᵢ can be selected such that sufficient friction is generated between the projections 42₁-42₂₈ and the drive wheels 22₁-22₃ in rotation to drive the endless track 21, even at high speed. In this case, the side surfaces 52₁, 52₂ of each projection 42ᵢ converge towards one another such that the projection 42ᵢ tapers towards its end surface 54. Also, due to this convergence, the recess defined by the projection 42ᵢ and an adjacent one of the projections 42₁-42₂₈ is a V-shaped recess.

Each of drive wheels 22₁-22₃ is mounted to an axle driven via power derived from the prime mover 12. Each of the drive wheels 22₁-22₃ has a periphery 50 for frictional engagement with the friction drive surface 44 of the endless snowmobile track 21 such that, when the drive wheels 22₁-22₃ rotate, friction between the friction drive surface 44 and the periphery 50 of each of the drive wheels 22₁-22₃ moves the track 21 so as to propel the snowmobile 10.

The periphery 50 of each of the drive wheels 22₁-22₃ may be configured in various manners. In this embodiment, the periphery 50 of each of the drive wheels 22₁-22₃ comprises a plurality of formations 60₁-60₃ that frictionally engage the recesses defined by adjacent ones of the projections 42₁, 42₂, 42₁₄, 42₁₅, 42₂₇, 42₂₈ of the friction drive surface 44 in order to impart motion to the track 21.

More particularly, in this embodiment, each of the formations 60₁-60₃ of the drive wheels 22₁-22₃ is a projection extending circumferentially on that drive wheel to form a circumferential ridge. Each of the projections 60₁-60₃ comprises an end surface 64 and a pair of side surfaces 62₁, 62₂ opposite one another. Adjacent ones of the projections 60₁-60₃ of each drive wheel define a recess therebetween. Thus, in this case, each of the drive wheels 22₁-22₃ is a sheave.

Each of the projections 60₁-60₃ of the drive wheels 22₁-22₃ has a height, which is measured from its end surface 64 to a level of the periphery 50 of the wheel from which it projects. The height of each of the projections 60₁-60₃ can be selected such that sufficient friction is generated between the friction drive surface 44 of the endless snowmobile track 21 and the drive wheels 22₁-22₃ in rotation to drive the track 21, even at high speed. The side surfaces 62₁, 62₂ of each of the projections 60₁-60₃ converge towards one another such that the projection tapers towards its end surface 64. Also, due to this convergence, the recesses defined by the projections 60₁-60₃ of the drive wheels 22₁-22₃ are V-shaped recesses.

The projections 42₁, 42₂, 42₁₄, 42₁₅, 42₂₇, 42₂₈ of the friction drive surface 44 of the endless snowmobile track 21 and the projections 60₁-60₃ of the drive wheels 22₁-22₃ are configured such that, when they are in contact, each of the projections 42₁, 42₂, 42₁₄, 42₁₅, 42₂₇, 42₂₈ of the track 21 occupies the recess defined by adjacent ones of the projections 60₁-60₃ of the drive wheels 22₁-22₃ while each of the projections 60₁-60₃ of the drive wheels 22₁-22₃ occupies the recess defined by adjacent ones of the projections 42₁, 42₂, 42₁₄, 42₁₅, 42₂₇, 42₂₈ of the track 21.

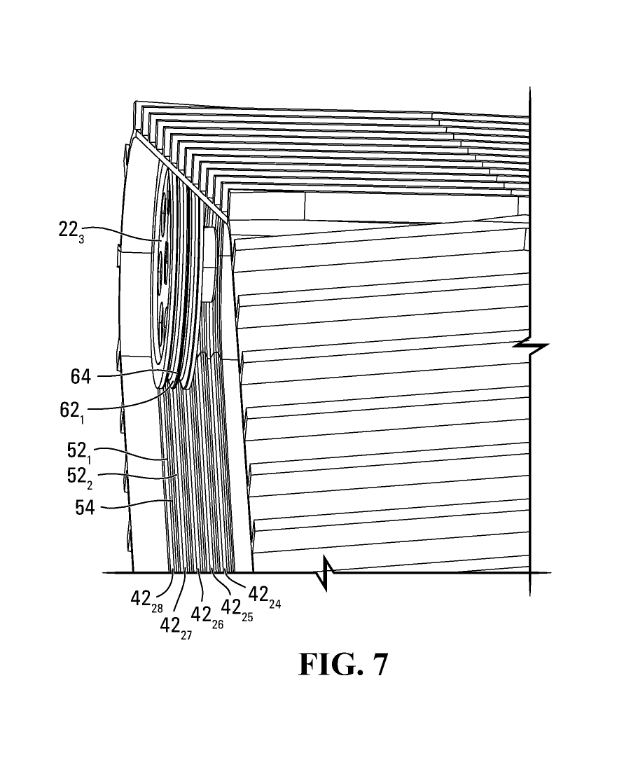

For example, FIG. 7 illustrates the relationship between the drive wheel 22₃ and the inner side 25 of the endless snowmobile track 21, and more specifically, the orientation of that drive wheel relative to the projections 42₂₇, 42₂₈ of the track 21. This is representative of the relationship each of the drive wheels 22₁-22₃ has with respective ones of the projections 42₁, 42₂, 42₁₄, 42₁₅, 42₂₇, 42₂₈ of the track 21.

In this case, the drive wheel 22₃ is oriented relative to the projections 42₂₇, 42₂₈ of the track 21 such that the central projection 60₂ of its periphery 50 engages the recess between the projections 42₂₇, 42₂₈. Specifically, the side surfaces 62₁, 62₂ and the end surface 64 of the projection 60₂ of the drive wheel 22₃ is resting within the recess that lies between the side surface 52₂ of the projection 42₂₈ and the side surface 52₁ of the projection 42₂₇. In a similar manner, the side surfaces 62₁, 62₂ of each of the projections 60₁-60₃ of the drive wheels 22₁-22₃ come into contact with the side surfaces 52₁, 52₂ of the projections 42₁, 42₂, 42₁₄, 42₁₅, 42₂₇, 42₂₈ of the track 21. This also allows the end surface 64 of the projections 60₁-60₃ of each of the drive wheels 22₁-22₃ to come into contact with a bottom surface of the recess between adjacent ones of the projections 42₁, 42₂, 42₁₄, 42₁₅, 42₂₇, 42₂₈ of the track 21, while the end surface 54 of each of the projections 42₁, 42₂, 42₁₄, 42₁₅, 42₂₇, 42₂₈ of the track 21 comes into contact with a bottom surface of the recess between adjacent ones of the projections 60₁-60₃ of the drive wheels 22₁-22₃.

The contact described above causes frictional engagement between the drive wheels 22₁-22₃ and the friction drive surface 44 of the endless snowmobile track 21. More specifically, in this embodiment, the frictional engagement between the drive wheels 22₁-22₃ and the projections 42₁, 42₂, 42₁₄, 42₁₅, 42₂₇, 42₂₈ of the track 21 allow these drive wheels, which rotate under power derived from the prime mover 12, to move the track 21 in order to propel the snowmobile 10 on the ground.

In particular, the friction drive surface 44 of the endless snowmobile track 21 has a surface area, referred to as a “friction drive surface area”, which is in contact with the drive wheels 22₁-22₃ when these wheels are frictionally engaged with the track 21. In this embodiment, the friction drive surface area corresponds to a summation of areas of the end surface 54 and the side surfaces 52₁, 52₂ of each of the projections 42₁, 42₂, 42₁₄, 42₁₅, 42₂₇, 42₂₈ of the track 21 and of the bottom surface of the recess between adjacent ones of the projections 42₁, 42₂, 42₁₄, 42₁₅, 42₂₇, 42₂₈ of the track 21 that are in contact with the end surface 64 and the side surfaces 62₁, 62₂ of each of the projections 60₁-60₃ of the drive wheels 22₁-22₃ and the bottom surface of the recess between adjacent ones of the projections 60₁-60₃ of the drive wheels 22₁-22₃,

The friction drive surface area is sufficient to allow the endless snowmobile track 21 and the snowmobile 10 to which it is mounted to be accelerated to and maintain high speeds.

For instance, in some embodiments, the friction drive surface area may be sufficient to allow the endless snowmobile track 21 to be driven by the drive wheels 22₁-22₃ at angular speeds up to at least 2000 rpm, in some cases at least 3000 rpm, in some cases at least 4000 rpm, and in some cases at least 5000 rpm. This can allow the snowmobile 10 to travel at speeds up to at least 80 km/h, in some cases at least 100 km/h, in some cases at least 120 km/h, in some cases at least 140 km/h, and in some cases at least 160 km/h.

For example, in some embodiments, to achieve such performance, the friction drive surface area may be at least 25 cm² per kW of power applicable to rotate the drive wheels 22₁-22₃ (i.e., the maximum power that can be delivered from the prime mover 12 to the axle on which each of the drive wheels 22₁-22₃ is mounted to rotate the drive wheels 22₁-22₃), in some cases at least 30 cm² per kW of power applicable to rotate the drive wheels 22₁-22₃, in some cases at least 35 cm² per kW of power applicable to rotate the drive wheels 22₁-22₃, in some cases at least 40 cm² per kW of power applicable to rotate the drive wheels 22₁-22₃, in some cases at least 45 cm² per kW of power applicable to rotate the drive wheels 22₁-22₃, in some cases at least 50 cm² per kW of power applicable to rotate the drive wheels 22₁-22₃, and in some cases at least 55 cm² per kW of power applicable to rotate the drive wheels 22₁-22₃.

As another example, in some embodiments, to achieve such performance, the friction drive surface area may be at least 15 cm² per Newton-meter (N-m) of torque applicable to rotate the drive wheels 22₁-22₃, in some cases at least 20 cm² per N-m of torque applicable to rotate the drive wheels 22₁-22₃, in some cases at least 25 cm² per N-m of torque applicable to rotate the drive wheels 22₁-22₃, in some cases at least 30 cm² per N-m of torque applicable to rotate the drive wheels 22₁-22₃, in some cases at least 35 cm² per N-m of torque applicable to rotate the drive wheels 22₁-22₃, in some cases at least 40 cm² per N-m of torque applicable to rotate the drive wheels 22₁-22₃, and in some cases at least 45 cm² per N-m of torque applicable to rotate the drive wheels 22₁-22₃.

With continued reference to FIGS. 1 to 8, in this embodiment, the drive wheels 22₁-22₃, the rear idler wheels 26₁-26₃, the lower support wheels 28₁, 28₂, and the upper support wheels 30₁, 30₂ are arranged so that the endless snowmobile track 21 has a parallelogram-like configuration. In this arrangement, the upper support wheels 30₁, 30₂ and the drive wheels 22₁-22₃ respectively form upper left and right corners of this parallelogram-like configuration, while the rear idler wheels 26₁-26₃ and the lower support wheels 28₁, 28₂ form its lower left and right corners, respectively.

The rear idler wheels 26₁-26₃ are spaced apart longitudinally from the drive wheels 22₁-22₃ in order to provide sufficient tension to the endless snowmobile track 21. The rear idler wheels 26₁-26₃ are mounted to an axle, but this axle is not driven by the prime mover 12 such that the rear idler wheels 26₁-26₃ are not driven by the prime mover 12.

In this embodiment, the rear idler wheels 26₁-26₃ are configured similarly to the drive wheels 22₁-22₃. For example, the rear idler wheels 26₁-26₃ also have a set of projections 60₁-60₃ along their periphery 50 much like the drive wheels 22₁-22₃. These projections are configured to fit within the recesses between adjacent ones of the projections 42₁-42₂₈ of the endless snowmobile track 21. In this way, the rear idler wheels 26₁-26₃ may engage certain ones of the projections 42₁-42₂₈ in a manner similar to that described previously in relation to the drive wheels 22₁-22₃. However, the rotation of each of the rear idler wheels 26₁-26₃ is in response to the motion of the track 21, rather than being driven directly in response to power supplied by the prime mover 12. In other words, the rear idler wheels 26₁-26₃ do not frictionally drive the endless track 21 as the frictional drive function is performed by the drive wheels 22₁-22₃.

Also, in this embodiment, the rear idler wheels 26₁-26₃ are arranged such that they engage certain ones of the projections 42₁-42₂₈ that are frictionally engaged by the drive wheels (e.g., the projections 42₁, 42₂ engaged by the drive wheel 22₁ are also engaged by the rear idler wheel 26₁). This may contribute to ensure sufficient tension is maintained in the track 21 so that power delivered by the drive wheels 22₁-22₃ is efficiently converted to motion. In other embodiments, the rear idler wheels 26₁-26₃ may be arranged so that they engage certain ones of the projections 42₁-42₂₈ of the endless snowmobile track 21 that are adjacent to, but not frictionally engaged by, the drive wheels 22₁-22₃. For example, the rear idler wheel 26₁ may engage the adjacent set of projections 42₃, 42₄ of the track 21.

The upper support wheels 30₁, 30₂ are generally at a common vertical level with the drive wheels 22₁-22₃, while the lower support wheels 28₁, 28₂ are generally at a common vertical level with the rear idler wheels 26₁-26₃. Along with the rear idler wheels 26₁-26₃, the upper support wheels 30₁, 30₂ and the lower support wheels 28₁, 28₂ help to maintain tension in the endless snowmobile track 21, as well as ensure that the track 21 maintains its shape and general orientation with the direction of motion of the snowmobile 10.

In this embodiment, the upper support wheels 30₁, 30₂ and the lower support wheels 28₁, 28₂ are smaller than the drive wheels 22₁-22₃ and the rear idler wheels 26₁-26₃ but are constructed similarly. In particular, each of the wheels 30₁, 30₂, 28₁, 28₂ includes a set of projections along its periphery that are similar to the projections 60₁-60₃ of the drive wheels 22₁-22₃. Thus, the projections 60₁-60₃ of the upper support wheels 30₁, 30₂ and the lower support wheels 28₁-28₄ may occupy the recesses between adjacent ones of the projections 42₁-42₂₈ of the endless snowmobile track 21 as the track 21 is driven. Like the rear idler wheels 26₁-26₃, the upper support wheels 30₁, 30₂ and the lower support wheels 28₁, 28₂ are rotated in response to the motion of the endless snowmobile track 21, rather than being driven directly in response to power supplied by the prime mover 12.

The support wheels 28₁, 28₂, 30₁, 30₂ may be arranged so that they engage certain ones of the projections 42₁-42₂₈ of the endless snowmobile track 21 that are not being engaged by either of the drive wheels 22₁-22₃ or the rear idler wheels 26₁-26₃. More specifically, these support wheels may engage some of the projections 42₁-42₂₈ that may be adjacent to those that are engaged by the drive wheels 22₁-22₃ and/or the rear idler wheels 26₁-26₃. Alternatively, some or all of the support wheels 28₁, 28₂, 30₁, 30₂ may be arranged so that they engage certain ones of the projections 42₁-42₂₈ of the endless snowmobile track 21 that are also being engaged by either of the drive wheels 22₁-22₃ or the rear idler wheels 26₁-26₃.

The sliders 33₁, 33₂ are elongated members that slide on the inner side 25 of the endless snowmobile track 21 along a bottom run of the track 21. As the track 21 is driven by the drive wheels 22₁-22₃, the sliders 33₁, 33₂ apply the bottom run of the track 21 onto the ground to enhance traction. In this embodiment, the sliders 33₁, 33₂ slide on a portion of the inner side 25 of the track 21 that is unengaged by the drive wheels 22₁-22₃. More particularly, in this embodiment, the sliders 33₁, 33₂ slide on a portion of the inner side 25 of the track 21 that is free of any of the projections 42₁-42₂₈. In other embodiments, the sliders 33₁, 33₂ may slide on a portion of the inner side 25 of the track 21 that includes some of the projections 42₁-42₂₈ (e.g., each slider may slide in one or more of the recesses defined by adjacent ones of the projections 42₁-42₂₈) since this may further contribute to guiding the track 21 as it turns around the track assembly 14.

The frictional engagement between the friction drive surface 44 of the endless snowmobile track 21 and the drive wheels 22₁-22₃ may allow the snowmobile 10 to accelerate to and maintain high speeds comparable to those attainable using more traditional sprocket-based drive systems while using less power. This reduction in the power needed to achieve these high speeds can allow a smaller prime mover to be installed in the snowmobile 10, resulting in reduction of the costs associated with the snowmobile 10 (e.g., both in terms of equipment cost and exploitation cost, due to reduced fuel consumption), as well as in the level of noise and air pollution emitted by the snowmobile 10 during use.

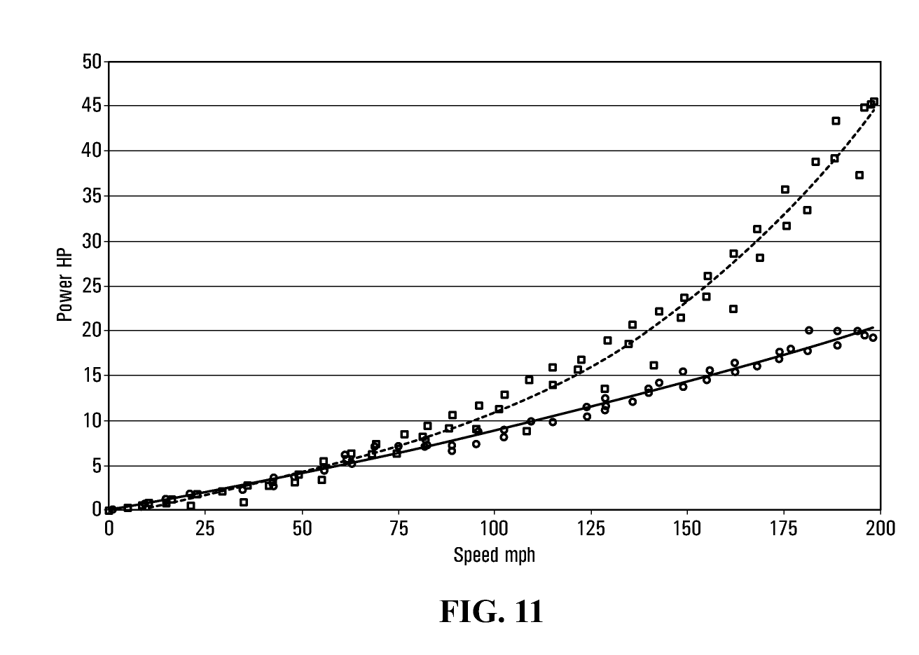

For example, FIG. 11 shows results of tests conducted on two (2) endless snowmobile tracks of comparable overall dimensions. The first track (square data points) had conventional drive lugs for engaging a drive sprocket, while the second track (circular data points) had a friction drive surface such as the friction drive surface 44 of the track 21 for frictional driving. The tracks were tested on a testing machine without traction to measure the power needed to move the track at a given speed. As can be seen, the frictionally-driven track required less power to be driven than the positively-driven track (i.e., the track with drive lugs) at most speeds, particularly at speeds above 50 mph where the difference became increasingly significant. Therefore, when driven at a given speed, the endless snowmobile track 21 may consume less power than would be consumed if the track assembly 14 was replaced with a comparative track assembly comprising: (i) at least one drive sprocket; and (ii) a comparative endless snowmobile track having a length and a width respectively identical to a length and a width of the endless snowmobile track 21 and comprising drive lugs and/or drive voids which are spaced apart along a longitudinal direction of the comparative endless snowmobile to engage the at least one drive sprocket.

The frictional engagement between the friction drive surface 44 of the endless snowmobile track 21 and the drive wheels 22₁-22₃ may also remove certain constraints that are normally placed on the design of conventional snowmobile tracks that are required when a drive sprocket is used to transfer motive force to such tracks via voids and/or drive lugs on the tracks. The removal of these constraints may allow the overall design of the endless snowmobile track 21 to be enhanced, resulting in better vehicular performance and handling than would otherwise be achieved.

In particular, the traction projections 31₁-31_{N} of the ground-engaging outer side 25 of the endless track 21 may be arranged in virtually any desired pattern. Specifically, since there is no need for drive lugs or drive voids in the endless snowmobile track 21, the arrangement of the traction projections 31₁-31_{N} is not constrained as it would be if such drive lugs or drive voids were present. The traction projections 31₁-31_{N} may thus be arranged in any desirable pattern to improve the traction and handling capabilities of the snowmobile 10.

While it is configured in a particular way in this embodiment, the track assembly 14 may be configured in various other ways in other embodiments.

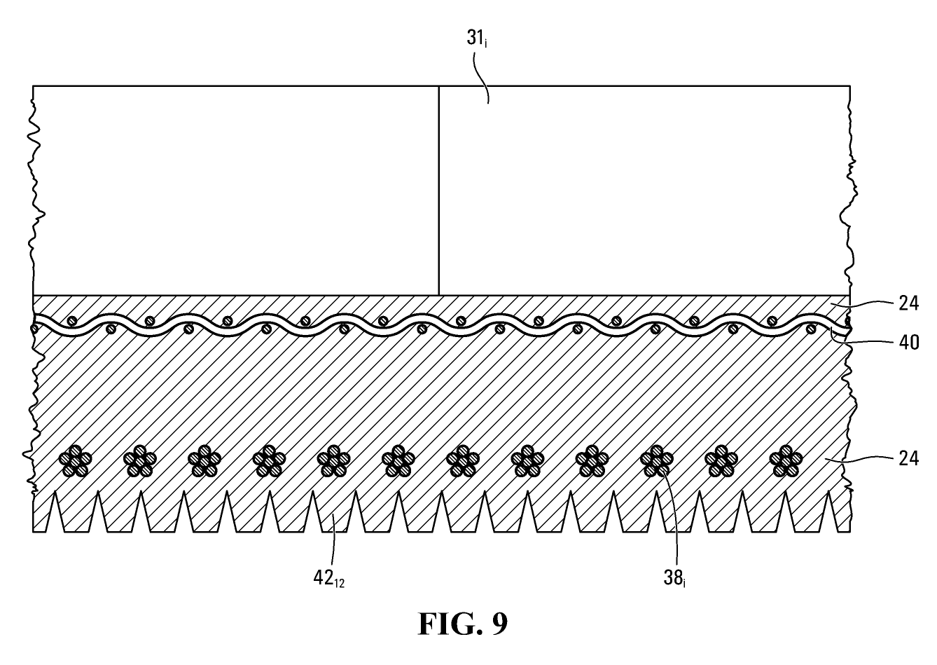

For instance, although it is constructed in a particular way in this embodiment, the endless snowmobile track 21 may be constructed in various other ways in other embodiments. For example, as shown in FIG. 9, in some embodiments, the endless snowmobile track 21 may be free of (i.e., lack) the transversal rods 36₁-36_{N}. In such embodiments, the resultant reduction in the transverse rigidity of the track 21 may enhance friction between the inner side 25 of the track 21 and the drive wheels 22₁-22₃. As another example, in some embodiments, the endless snowmobile track 21 may have a main body made of various materials instead of or addition to elastomeric material, such as urethane or other plastic material or composite material.

The friction drive surface 44 of the endless snowmobile track 21 may be configured in various other ways in other embodiments in order to enable the track 21 to be frictionally driven.

For example, in some embodiments, the friction drive surface 44 may comprise any number of projections such as the projections 42₁-42₂₈ that have various other shapes and/or are arranged in various other patterns. As another example, in some embodiments, the friction drive surface 44 may comprise a plurality of recesses that are not formed by projections such as the projections 42₁-42₂₈ but are rather receding inwardly from a main level of the friction drive surface 44 and frictionally engage portions of the drive wheels 22₁-22₃. In other examples, various combinations of complementary male parts and female parts distributed between the friction drive surface 44 and the drive wheels 22₁-22₃ and frictionally engageable with one another may be used to frictionally drive the track 21.

As another example, in some embodiments, instead of comprising male parts and/or female parts engaging complementary female parts and/or male parts of the drive wheels 22₁-22₃, the friction drive surface 44 may have a coefficient of friction with the drive wheels 22₁-22₃ that is sufficient for frictional driving of the track 21 without requiring such complementary male/female parts. For instance, in some cases, the friction drive surface 44 may be made of a rubber compound having a coefficient of friction with the drive wheels 22₁-22₃ or may have a texture with a surface roughness enhancing its “grip” on the drive wheels 22₁-22₃. In other embodiments, the friction drive surface 44 and the drive wheels 22₁-22₃ may comprise complementary male/female parts in addition to having a high coefficient of friction.

The drive wheels 22₁-22₃ may also be configured in various other ways in other embodiments in order to frictionally drive the endless snowmobile track 21. For example, in some embodiments, the drive wheels 22₁-22₃ may comprise any number of projections such as the projections 60₁-60₃ or other male pale parts and/or female parts that may have various other shapes and/or may be arranged in various other ways on their periphery 50. Also, in some embodiments, one (1), two (2) or any other number of drive wheels such as the drive wheels 22₁-22₃ may be used to frictionally drive the endless snowmobile track 21.

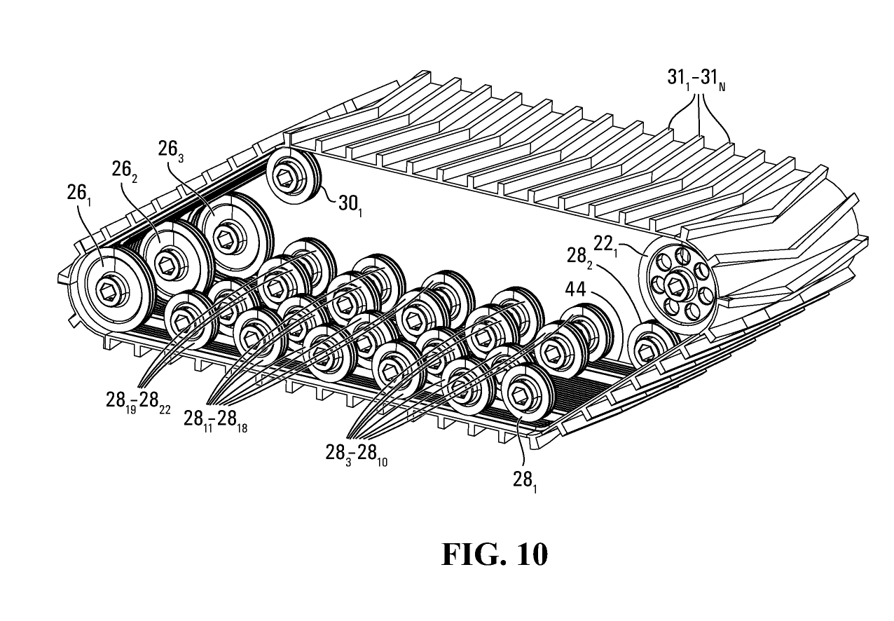

The wheels 26₁-26₃, 28₁, 28₂, 30₁, 30₂ and/or the sliders 33₁, 33₂ may also be configured and/or arranged in other ways in other embodiments, and/or some of these wheels and sliders may be omitted and/or joined by other such wheels or sliders in other embodiments. For example, FIG. 10 shows an embodiment in which the sliders 33₁, 33₂ are omitted and the track assembly 14 comprises additional lower support wheels 28₃-28₂₂ distributed in four (4) rows generally parallel to the longitudinal direction of the endless snowmobile track 21. As the track 21 is driven by the drive wheels 22₁-22₃, the lower support wheels 28₃-28₂₂ roll on the inner side 25 of the track 21 and apply the bottom run of the track 21 onto the ground to enhance traction. In addition, since they engage some of the projections 42₁-42₂₈ of the track 21, the lower support wheels 28₃-28₂₂ also contribute to guiding the track 21 as it turns around the track assembly 14. As another example, in some embodiments, additional upper support wheels such as the support wheels 30₁, 30₂ may be provided.

Although in this embodiment the snowmobile 10 comprises a single track assembly 14, in other embodiments, the snowmobile 10 may comprise two (2) or more track assemblies that are similar to the track assembly 14. For example, in some embodiments, the snowmobile 10 may comprise two (2) such track assemblies, with one on each lateral side of the snowmobile 10.

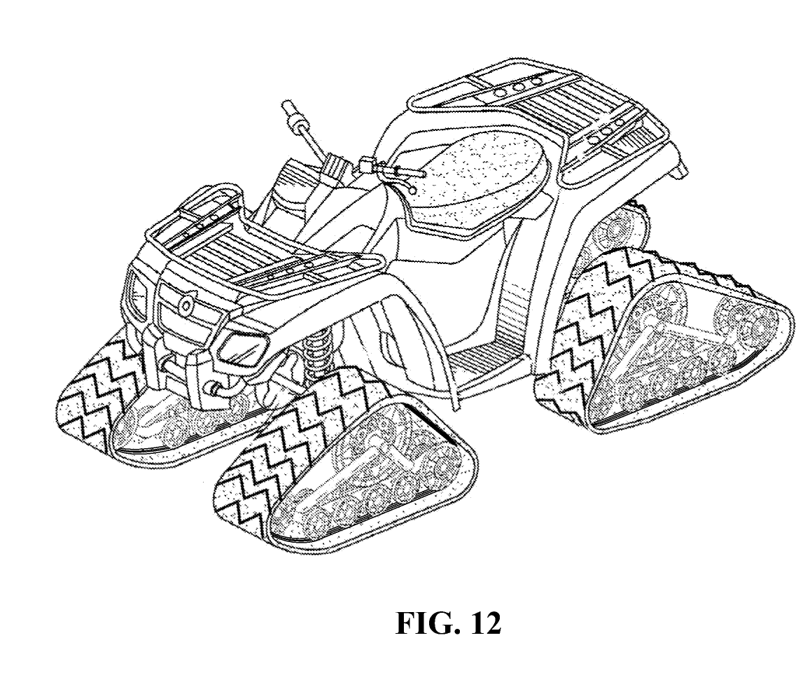

While the embodiment considered above relates to a snowmobile, in other embodiments, as shown in FIG. 12, an all-terrain vehicle (ATV) may comprise track assemblies similar to the track assembly 14 with a frictionally drivable endless ATV track in order to propel the ATV on the ground. Indeed, ATVs, like snowmobile, are also often driven at high speed and principles described herein to frictionally drive the endless snowmobile track 21 at high speed may be applied to endless ATV tracks for propelling ATVs.

Although various embodiments and examples have been presented, this was for the purpose of describing, but not limiting, the invention. Various modifications and enhancements will become apparent to those of ordinary skill in the art and are within the scope of the invention, which is defined by the appended claims.

1. An endless snowmobile track for traction of a snowmobile, the endless snowmobile track comprising:
a ground-engaging outer side for engaging the ground on which the snowmobile travels; and
an inner side for engaging at least one drive wheel of the snowmobile, the inner side comprising a friction drive surface for frictional engagement with the at least one drive wheel such that, when each of the at least one drive wheel rotates, friction between the friction drive surface and the at least one drive wheel moves the endless snowmobile track to propel the snowmobile on the ground.

2. The endless snowmobile track claimed in claim 1, wherein the friction drive surface comprises a plurality of male parts for frictionally engaging a plurality of female parts of the at least one drive wheel.

3. The endless snowmobile track claimed in claim 1, wherein the friction drive surface comprises a plurality of female parts for frictionally engaging a plurality of male parts of the at least one drive wheel.

4. The endless snowmobile track claimed in claim 1, wherein the friction drive surface comprises: a plurality of male parts for frictionally engaging a plurality of female parts of the at least one drive wheel; and a plurality of female parts for frictionally engaging a plurality of male parts of the at least one drive wheel.

5. The endless snowmobile track claimed in claim 1, wherein the friction drive surface comprises a plurality of projections extending generally parallel to one another in a longitudinal direction of the endless snowmobile track, the at least one drive wheel comprising a plurality of recesses extending circumferentially, the projections being dimensioned to frictionally engage respective ones of the recesses.

6. The endless snowmobile track claimed in claim 5, wherein the plurality of projections comprises at least four projections.

7. The endless snowmobile track claimed in claim 5, wherein the plurality of projections comprises at least six projections.

8. The endless snowmobile track claimed in claim 5, wherein each of the projections has a base and a top end and tapers in a direction from the base towards the top end.

9. The endless snowmobile track claimed in claim 5, wherein adjacent ones of the projections define a V-shaped recess therebetween.

10. The endless snowmobile track claimed in claim 1, wherein the friction drive surface has a surface area in contact with the at least one drive wheel when the friction drive surface frictionally engages the at least one drive wheel, the surface area being sufficient to allow the endless snowmobile track to be driven by the at least one drive wheel at angular speeds up to at least 2000 rpm.

11. The endless snowmobile track claimed in claim 1, wherein the friction drive surface has a surface area in contact with the at least one drive wheel when the friction drive surface frictionally engages the at least one drive wheel, the surface area being sufficient to allow the endless snowmobile track to be driven by the at least one drive wheel at angular speeds up to at least 3000 rpm.

12. The endless snowmobile track claimed in claim 1, wherein the friction drive surface has a surface area in contact with the at least one drive wheel when the friction drive surface frictionally engages the at least one drive wheel, the surface area being sufficient to allow the endless snowmobile track to be driven by the at least one drive wheel at angular speeds up to at least 4000 rpm.

13. The endless snowmobile track claimed in claim 1, wherein the friction drive surface has a surface area in contact with the at least one drive wheel when the friction drive surface frictionally engages the at least one drive wheel, the surface area being sufficient to allow the endless snowmobile track to be driven by the at least one drive wheel at angular speeds up to at least 5000 rpm.

14. The endless snowmobile track claimed in claim 1, wherein the friction drive surface has a surface area in contact with the at least one drive wheel when the friction drive surface frictionally engages the at least one drive wheel, the surface area being sufficient to allow the snowmobile to travel at speeds up to at least 80 km/h.

15. The endless snowmobile track claimed in claim 1, wherein the friction drive surface has a surface area in contact with the at least one drive wheel when the friction drive surface frictionally engages the at least one drive wheel, the surface area being sufficient to allow the snowmobile to travel at speeds up to at least 120 km/h.

16. The endless snowmobile track claimed in claim 1, wherein the friction drive surface has a surface area in contact with the at least one drive wheel when the friction drive surface frictionally engages the at least one drive wheel, the surface area being sufficient to allow the snowmobile to travel at speeds up to at least 160 km/h.

17. The endless snowmobile track claimed in claim 1, wherein the friction drive surface has a surface area in contact with the at least one drive wheel when the friction drive surface frictionally engages the at least one drive wheel, the surface area being at least 25 cm² per kW of power applicable to rotate the at least one drive wheel.

18. The endless snowmobile track claimed in claim 1, wherein the friction drive surface has a surface area in contact with the at least one drive wheel when the friction drive surface frictionally engages the at least one drive wheel, the surface area being at least 40 cm² per kW of power applicable to rotate the at least one drive wheel.

19. The endless snowmobile track claimed in claim 1, wherein the friction drive surface has a surface area in contact with the at least one drive wheel when the friction drive surface frictionally engages the at least one drive wheel, the surface area being at least 55 cm² per kW of power applicable to rotate the at least one drive wheel.

20. The endless snowmobile track claimed in claim 1, wherein the friction drive surface has a surface area in contact with the at least one drive wheel when the friction drive surface frictionally engages the at least one drive wheel, the surface area being at least 15 cm² per N-m of torque applicable to rotate the at least one drive wheel.

21. The endless snowmobile track claimed in claim 1, wherein the friction drive surface has a surface area in contact with the at least one drive wheel when the friction drive surface frictionally engages the at least one drive wheel, the surface area being at least 30 cm² per N-m of torque applicable to rotate the at least one drive wheel.

22. The endless snowmobile track claimed in claim 1, wherein the friction drive surface has a surface area in contact with the at least one drive wheel when the friction drive surface frictionally engages the at least one drive wheel, the surface area being at least 45 cm² per N-m of torque applicable to rotate the at least one drive wheel.

23. The endless snowmobile track claimed in claim 1, wherein the at least one drive wheel is a plurality of drive wheels spaced apart from one another along a widthwise direction of the endless snowmobile track.

24. The endless snowmobile track claimed in claim 1, wherein the ground-engaging outer side comprises a plurality of traction projections, at least part of a given one of the traction projections extending obliquely to a longitudinal direction of the endless snowmobile track.

25. The endless snowmobile track claimed in claim 24, wherein the given one of the traction projections comprises two portions converging toward one another in a direction of forward motion of the snowmobile.

26. The endless snowmobile track claimed in claim 1, wherein the friction drive surface has a coefficient of friction with the at least one drive wheel sufficient to frictionally drive the endless snowmobile track.

27. A track assembly for traction of a snowmobile, the track assembly comprising:
a plurality of wheels; and
an endless snowmobile track disposed around the wheels, the endless snowmobile track comprising:
a ground-engaging outer side for engaging the ground on which the snowmobile travels; and
an inner side for engaging the wheels, the inner side comprising a friction drive surface,
the plurality of wheels comprising:
at least one drive wheel for driving the endless snowmobile track, each of the at least one drive wheel having a periphery for frictional engagement with the friction drive surface such that, when each of the at least one drive wheel rotates, friction between the friction drive surface and the periphery of each of the at least one drive wheel moves the endless snowmobile track to propel the snowmobile on the ground; and
at least one idler wheel spaced apart from the at least one drive wheel along a longitudinal direction of the track assembly.

28. An endless all-terrain vehicle (ATV) track for traction of an ATV, the endless ATV track comprising:
a ground-engaging outer side for engaging the ground on which the ATV travels; and
an inner side for engaging at least one drive wheel of the ATV, the inner side comprising a friction drive surface for frictional engagement with the at least one drive wheel such that, when each of the at least one drive wheel rotates, friction between the friction drive surface and the at least one drive wheel moves the endless ATV track to propel the ATV on the ground.

29. A track assembly for traction of an all-terrain vehicle (ATV), the track assembly comprising:
a plurality of wheels; and
an endless ATV track disposed around the wheels, the endless ATV track comprising:
a ground-engaging outer side for engaging the ground on which the ATV travels; and
an inner side for engaging the wheels, the inner side comprising a friction drive surface,
the plurality of wheels comprising:
at least one drive wheel for driving the endless ATV track, each of the at least one drive wheel having a periphery for frictional engagement with the friction drive surface such that, when each of the at least one drive wheel rotates, friction between the friction drive surface and the periphery of each of the at least one drive wheel moves the endless ATV track to propel the ATV on the ground; and
at least one idler wheel spaced apart from the at least one drive wheel along a longitudinal direction of the track assembly.
